(19) United States
(12) Patent Application Publication
(10) Pub. No.: US 2017/0067996 A1
(43) Pub. Date: Mar. 9, 2017

(54) GROUND-BASED LASER RANGING SYSTEM FOR IDENTIFICATION AND TRACKING OF ORBITAL DEBRIS

(71) Applicant: U.S.A. as represented by the Administrator of the National Aeronautics and Space Administration, Washington, DC (US)

(72) Inventors: DONALD B. COYLE, Ellicott City, MD (US); PAUL R. STYSLEY, Catonsville, MD (US)

(21) Appl. No.: 14/846,423

(22) Filed: Sep. 4, 2015

(51) Int. Cl. G01S 17/66; G01S 13/86; G01S 17/02; G01S 7/00; B64G 1/10; B64G 3/00

(52) U.S. Cl. CPC G01S 17/66; B64G 1/10; B64G 3/00; G01S 17/023; G01S 7/003; G01S 13/865

(57) ABSTRACT

A ground-based laser ranging system and method are provided that enable meter-level or better ranging precision on optically passive 10-30 cm average-sized orbital debris targets. The system and method can improve current predictions by up to 85%. The improved location accuracy also provides the immediate benefit of reducing costly false alarms in collision predictions for existing assets and unidentified debris. The system can include one or more high power lasers that generate 1.5 μm wavelength laser pulses at >100 mJ pulse energies and at a repetition rate of from 10 Hz to 100 Hz.

### STATEMENT REGARDING FEDERALLY SPONSORED RESEARCH OR DEVELOPMENT

The invention described herein was made in part by employees of the United States Government and may be manufactured and used by or for the Government of the United States of America for governmental purposes without the payment of any royalties thereon or therefore.

### FIELD OF THE INVENTION

The present invention relates to a system and method for identifying and tracking orbital debris.

### BACKGROUND OF THE INVENTION

The mitigation of orbital debris was addressed in the most recent release of the National Space Policy directing space faring agencies to pursue technologies that will mitigate and remove on-orbit debris. No matter what abatement technology is developed and deployed, a remote sensing infrastructure to locate and track these objects with adequate precision is still lacking.

Orbital debris has become a national and worldwide issue for orbital assets, past, future and present, a risk to manned space flight and the International Space Station (ISS), and an ever-increasing hazard to Earths citizenry due to uncontrolled reentries of dead or wayward satellites. The amount of such debris is reaching a critical level, with current estimates of space debris with mean diameters of 1 cm or greater now exceeding 500,000. Worse yet, the number of critical-size space debris items with diameters of 10 cm or greater and enough impact energy to break up their target has reached about 21,000, with a total mass in orbit of nearly 6,000 metric tons. A catalog of these critical size debris objects is constantly monitored and updated, but with limited resolution. Unless the orbital characteristics of the debris object are known more precisely, the most effective debris removal and mitigation methods can do little more to address this problem than RF and passive optical techniques. Awareness of these risks are ramping up and efforts are underway to generate new technologies and methods for debris mitigation.

Using ground based lasers to track orbiting objects is a well understood, and worldwide-employed technology, with various lasers, pulse characteristics, detection, and tracking schemes. These techniques are all typically used and performed daily across the globe to track “laser cooperative” objects. A “cooperative” object is defined as a satellite with retro-reflectors installed on its surface, and pointed in some fashion toward the Earth. This enables the high resolution ranging stations to operate with low power, visible laser wavelengths at eye safe parameters in concert with smaller, less expensive telescopes for the laser pulse return detection. In order to adapt laser ranging techniques to “uncooperative” objects, i.e., random orbiting debris, much larger optical collection techniques as well as greater laser pulse energies are required.

### SUMMARY OF THE INVENTION

According to one or more embodiments of the present invention, a ground-based laser ranging system and method are provided that enable meter-level or better ranging precision on optically passive 10-30 cm average-sized orbital debris targets. The system and method is expected to improve current predictions by up to 85%. The improved location accuracy is also expected to provide the immediate benefit of reducing costly false alarms in collision predictions for existing assets and unidentified debris. In accordance with various embodiments of the present invention, it has been determined that the use of a Joule-class Nd: YAG laser at 1064 nm or 532 nm wavelengths can be used to track some uncooperative objects, but the impact on commercial aircraft forbids continuous or on-demand operations over most of the Earth. Thus, according to the present invention, using a joule-class laser in eye-safe wavelengths solves this problem.

According to one or more embodiments of the present invention, the cooperative network includes one or more ground-based laser ranging facilities at least one of which includes a high power laser system that can deliver pulsed laser beams having a wavelength of from 1.4 micrometers (μm) to 1.9 μm, pulsed at a repetition rate of from 10 hertz (Hz) to 100 Hz. In some embodiments, the high power laser can comprise a dual head laser as disclosed in U.S. Pat. No. 8,958,452 B2 to Coyle at el., which is incorporated herein in its entirety by reference. In some embodiments, the high power laser can comprise an Nd: YAG oscillator, laser system, spacecraft, or combination thereof as described in concurrently filed U.S. patent application Ser. No. ______ to Stysley et al. entitled “Nd: YAG Oscillator-Based Three-Wavelength Laser System” (Attorney Docket No. GSC-17345-1), which is incorporated herein in its entirety by reference. The high power laser can produce pulse energies of 100 mJ or greater, TEM₀₀ beam quality, and low divergence, without requiring further amplification. Such high power lasers can provide improved resolution and tracking and can enable enhanced capabilities and accuracy of the orbital debris tracking cooperative network.

### BRIEF DESCRIPTION OF THE DRAWINGS

The present invention can be even more fully understood with the reference to the accompanying drawings which are intended to illustrate, not limit, the present invention.

FIG. 1 is a graph showing the relative number of critical-sized (d>10 cm) orbital debris objects, and showing the highest concentrations residing at altitudes of between 700-900 km above the Earth's surface.

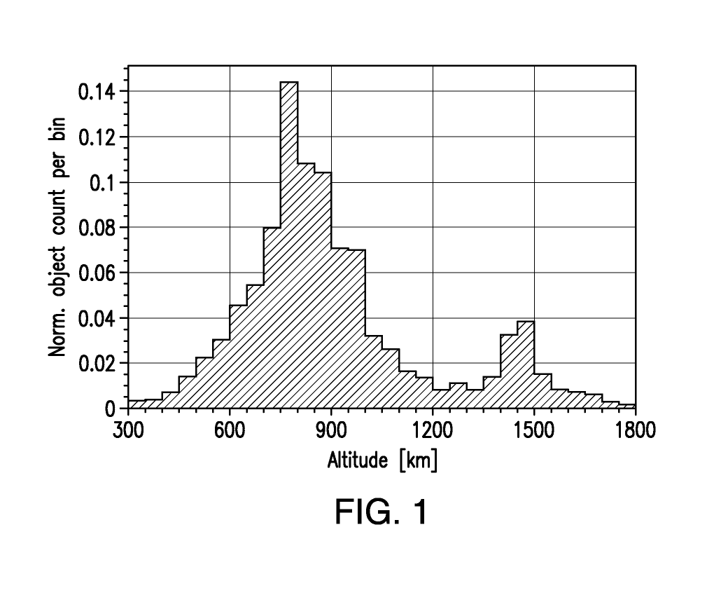

FIG. 2 is a schematic diagram showing a cooperative network of Orbital Debris Laser Ranging (ODLR), satellite laser ranging (SLR), and Debris Radar tracking facilities, and exemplifies the open sharing of data products, and the incorporation of Joint Space Operations Center (JSpOC) and Crustal Dynamics Data Information System (CDDIS) procedures and processes. The network greatly reduces the false alarm collision warnings with space assets and significantly increases the accuracy of identifying known objects and discovering many more.

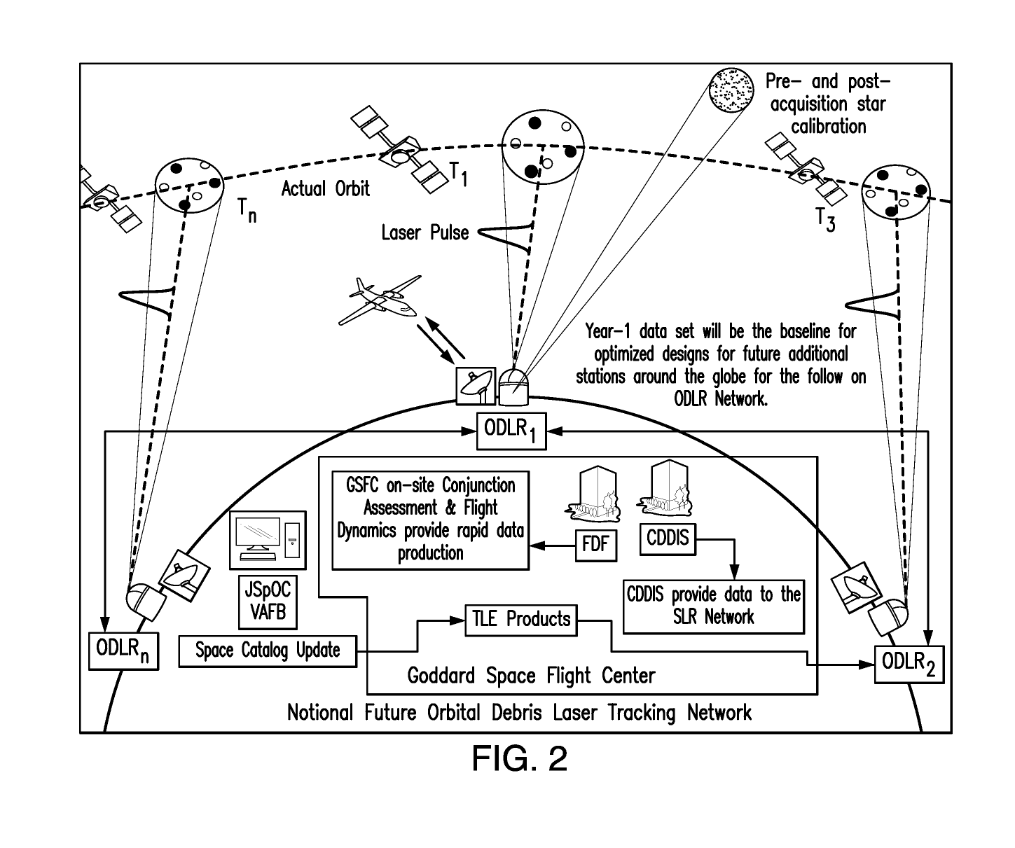

### DETAILED DESCRIPTION OF THE INVENTION

According to various embodiments of the present invention, a system of laser ranging tracking facilities for tracking an orbital debris target in low Earth orbit, is provided. The system can comprise a plurality of laser ranging stations comprising at least two ground-based laser ranging stations that can be separated from one another, for example, spaced around the globe or separated by one another by at least 100 miles. Each laser ranging station can detect an orbital debris target and can transmit to a central processor a respective signal indicative of the orbit of the orbital debris target. The system can include a central processor having a receiver configured to receive transmitted signals from the laser ranging stations. The processor can be configured to process the signals received by the receiver into data sets each pertaining to the orbit of a respective the orbital debris target. A datastore can be provided and configured to store the data sets pertaining to the orbit of the orbital debris target. At least one of the ground-based laser ranging stations can comprise a high power laser configured to provide laser pulses at a wavelength of from 0.5 μm to 2.5 μm at a pulse energy of 100 mJ or greater and at a repetition rate of from 10 Hz to 100 Hz. In an exemplary embodiment, the high power laser is configured to provide laser pulses at a wavelength of from 1.4 μm to 1.9 μm, at a pulse energy of 100 mJ or greater, and at a repetition rate of from 10 Hz to 100 Hz. For example, the high power laser can be configured to provide pulsed laser light at a wavelength of about 1.5 μm, for eye safe applications. High power lasers of such specifications can beneficially provide reliable tracking of orbital debris targets that are non-compliant, uncooperative, or both.

According to various embodiments, the processor can be configured to process the data sets into orbital data pertaining to the orbit of the orbital debris target, store the orbital data in the datastore, and calculate a future orbit path of the orbital debris target based on the stored orbital data. The calculated future orbit of the debris target can be used to determine whether an existing low Earth orbit asset, such as a satellite, needs to be repositioned to avoid a collision with the orbital debris target.

The system can further comprise at least one laser ranging satellite configured to detect an orbital debris target and transmit a signal to the central processor, which is indicative of the orbit of the orbital debris target. The receiver of the central processor can be configured to receive signals from the laser ranging satellite. The laser ranging satellite can comprise a high power laser configured to provide laser pulses at a wavelength from 1.0 μm to 1.9 μm at a pulse energy of 100 mJ or greater and at a repetition rate of from 10 Hz to 100 Hz, for example, a wavelength of about 1.5μm. The system can additionally, or alternatively, comprise a radio frequency radar station configured to track the orbital debris target and transmit a respective signal indicative of the orbit of the orbital debris target, to the receiver, and the receiver can be configured to receive signals from the radio frequency radar station.

According to various embodiments, the system can additionally, or alternatively, comprise a passive optical tracking radar station configured to track the orbital debris target and transmit a respective signal indicative of the orbit of the orbital debris target, to the receiver, and the receiver can be configured to receive signals from the passive optical tracking radar station. According to various embodiments of the present invention, a method of tracking an orbital debris target in low Earth orbit is provided. The method can comprise laser ranging the orbital debris target using a plurality of laser ranging stations comprising at least two ground-based laser ranging stations. The at least two ground-based laser ranging stations can be spaced around the globe, for example, separated from one another by at least 100 miles. The method can involve transmitting a respective signal from each of the laser ranging stations, indicative of the orbit of the orbital debris target. The receiver can receive the transmitted signals from the laser ranging stations and a processor can process the signals received by the receiver into data sets each pertaining to the orbit of the orbital debris target. The data sets pertaining to the orbit of the orbital debris target can be stored in a datastore. At least one of the ground-based laser ranging stations can be configured to laser range with a high power laser that provides laser pulses at a wavelength of from 1.4 μm to 1.9 μm at a pulse energy of 100 mJ or greater and at a repetition rate of from 10 Hz to 100 Hz. In an example, the high power laser can provide pulsed laser light at a wavelength of about 1.5 μm.

The method can use a processor that processes the data sets into orbital data pertaining to the orbit of the orbital debris target, stores the orbital data in the datastore, and calculates a future orbit path of the orbital debris target based on the stored orbital data. The method can further comprise laser ranging the orbital debris target with at least one laser ranging satellite and transmitting a satellite signal from the laser ranging satellite to the receiver. The satellite signal can be indicative of the orbit of the orbital debris target. The receiver can receive the satellite signal and process the satellite signal into a data set pertaining to the orbit of the orbital debris target. The laser ranging satellite can produce high power laser pulses at a wavelength from 1.0 μm to 1.9 μm at a pulse energy of 100 mJ or greater and at a repetition rate of from 10 Hz to 100 Hz. In an eye-safe example, the high power laser of the laser ranging satellite produces pulsed laser light at a wavelength of about 1.5 μm.

According to various embodiments, the method can further comprise tracking the orbital debris target with a radio frequency radar station and transmitting a respective signal indicative of the orbit of the orbital debris target, to the receiver. The receiver can receive signals from the radio frequency radar station and process the signal received from the radio frequency radar station into a data set pertaining to the orbit of the orbital debris target. Additionally or alternatively, the method can comprise tracking the orbital debris target with a passive optical tracking station and transmitting a respective signal indicative of the orbit of the orbital debris target, to the receiver, and the receiver can receive signals from the passive optical tracking station and process the signal received from the passive optical tracking station into a data set pertaining to the orbit of the orbital debris target. In some embodiments, the orbital debris target tracked can be a compliant target, a cooperative target, or both. In some embodiments, the orbital debris target tracked can be a non-compliant target, an uncooperative target, or both. According to various embodiments, the method can further comprise optically tracking the orbital debris target with a passive optical tracking station based on the data sets stored in the datastore.

According to various embodiments, the method can comprise also tracking a second orbital debris target using the plurality of laser ranging stations, and storing, in the datastore, data sets pertaining to the orbit of the second orbital debris target. The data sets of both the orbital debris target and the second orbital debris target can be cataloged in the datastore. Information from the cataloged data sets can be compared to positional information pertaining to a low Earth orbit asset and, if necessary, the asset can be repositioned based on the comparison, for example, to avoid a collision.

According to various embodiments of the present invention, a system and method for adapting laser ranging and optical tracking capabilities on selected, optically-uncooperative (no retro reflectors) orbital debris targets in low Earth orbit (LEO). The system and method can be utilized, for example, at NASA's Goddard Space Flight Center (GSFC) in Greenbelt, Md., and more particularly at the NASA-GSFC Goddard Geophysical and Astronomical Observatory (GGAO) laser ranging facility.

According to various embodiments, one or more laser ranging facilities are used in a worldwide network of sites to locate and track orbital debris. As an example, NASA's GGAO 1.2 meters (1.2 m) laser ranging facility can be used as an ODLR laboratory to develop, demonstrate, and facilitate a worldwide network of adaptive or new sites dedicated to aid the orbital debris abatement community. Although the GGAO 1.2 m laser ranging facility was built as one of the first dedicated facilities for laser ranging to man-made orbiting satellites, it has been used for a wide variety of experiments. Recently, the facility was used to provide on-orbit and in-cruise calibration for laser altimeter instruments as described in Sun et al., “Laser Ranging between the Mercury Laser Altimeter and an Earth-based Laser Satellite Tracking Station over a 24-million-km Distance,” OSA Annual Meeting, Tucson Ariz., Oct. Proceedings, (2005), which is incorporated herein in its entirety by reference. See also Smith et al., “Two-Way Laser Link over Interplanetary Distance,” Science Magazine, 311 (Jan. 6, 2006), which is incorporated herein in its entirety by reference. Such a facility can be continually updated and upgraded to keep pace with evolving tracking technology, for example, by periodic upgrades and recoating of the telescope optics. The systems and methods of the present invention do not necessarily need to compete with the current infrastructure of RF radar and passive optical tracking centers, but can add capability to the ongoing debris tracking network. For example, the present invention can incorporate sub-meter level skin tracking data products into the orbital debris database for the largest and riskiest targets. The new data products can be incorporated into the current and active database and assist in any object tracking requests by the orbital debris community. The improved resolution tracking data allows conjunction assessment predictions to be refined, reducing false reports of imminent risks. By building on decades of sub-centimeter-precision laser ranging expertise and technology advancement for the geoscience community, the present invention can provide information useful in making minor adaptations in hardware, software, and procedures and can quickly demonstrate ground based capabilities that will advance the orbital predictions of selected high-risk targets to the meter-level regime, in a short amount of time and at relatively low cost.

### Network and Modeling

The present invention provides significant improvements over current RF and passive optical tracking methods by achieving meter-level ranging precision on passive targets. Feedback from initial results can be used to determine ranging link boundary conditions in debris size and orbit altitude, and can be used to quantify system improvements that might be needed to optimize this much-needed capability.

Navigation analysis can be conducted using the Orbit Determination Toolbox (ODTBX), developed and used extensively by Goddard's Navigation & Mission Design Branch. Assorted initial conditions and perturbations such as Solar and Lunar effects, solar radiation pressure and atmospheric drag can all be incorporated to produce a first order prediction of a LEO object's orbit. A plurality of different SLR facilities can be used to track a single object, for example, as it orbits the Earth and/or over a period of time. For example, three representative SLR facilities such as those located in Greenbelt, Md. (GGAO), White Sands, New Mexico, and Canberra, Australia, can provide periodic tracking of a single object for a period of 24 hours. SLR measurements of the passive target are simulated and processed in a weighted batch least-squares estimator to assess orbit determination accuracy. A linear covariance analysis considering errors in the object's position, velocity, and atmospheric drag modeling can be used to show that deterministic position uncertainties at the meter-level are possible using SLR measurements.

Preliminary analysis suggests that using SLR measurements yields higher precision estimates of the debris object's orbit. We know from routine sub-cm ranging accuracies to orbital cooperative targets over the last few decades that meter-level first order ranging can be achieved with relative ease using NASA's current state of operation. By optimizing the system, according to the present invention, for the higher variant properties of orbital debris, the repeatability and capability of the system can be improved likewise, and can be reproduced inexpensively around the globe. There are agreements in place at several international SLR stations with NASA that can contribute to this work.

Table 1 below lists the various International Laser Ranging Service (ILRS) system locations in the global network of NASA's cooperative geophysical SLR ground station. Laser system sites can be brought online across the world, for example, one in South America, one in Europe, one in North America, and one in Japan. Mobile systems can also be used in the global network.

TABLE 1

| | | | | IERS | IGS | | IDS |
|---|---|---|---|---|---|---|---|
| | | Location Name, | CDDIS | DOMES | Site | IVS | Site |
| Monument | Code | Country | SOD | Numbers | Log | Site Log | Log |
| 1824 | GLSL | Golosiiv, | 18248101 | 12356S001 | GLSV | — | — |
| | | Ukraine | | | | | |
| 1831 | LVIL | Lviv, Ukraine | 18318501 | 12368S001 | SULP | — | — |
| 1863 | MAID | Maidanak 2, | 18635101 | 12340S001 | — | — | — |
| | | Uzbekistan | | | | | |
| 1864 | MAIL | Maidanak 1, | 18645401 | 12340S002 | — | — | — |
| | | Uzbekistan | | | | | |
| 1868 | KOML | Komsomolskna- | 18685901 | 12341S001 | — | — | — |
| | | Amure, | | | | | |
| | | Russia | | | | | |
| 1873 | SIML | Simeiz, Ukraine | 18734901 | 12337S003 | CRAO | CRIMEA | — |
| 1874 | MDVS | Mendeleevo 2, | 18748301 | 12309S003 | MDVJ | — | — |
| | | Russia | | | | | |
| 1879 | ALTL | Altay, Russia | 18799401 | 12372S001 | — | — | — |
| 1884 | RIGL | Riga, Latvia | 18844401 | 12302S002 | RIGA | — | — |
| 1886 | ARKL | Arkhyz, Russia | 18869601 | 12373S001 | — | — | — |
| 1887 | BAIL | Baikonur, | 18879701 | 25603S001 | — | — | — |
| | | Kazakhstan | | | | | |
| 1888 | SVEL | Svetloe, Russia | 18889801 | 12350S002 | SVTL | SVETLOE | — |
| 1889 | ZELL | Zelenchukskya, | 18899901 | 12351S002 | ZECK | ZELENCHK | — |
| | | Russia | | | | | |
| 1890 | BADL | Badary, Russia | 18900901 | 12338S004 | BADG | BADARY | BADB |
| 1891 | IRKL | Irkutsk, Russia | 18915301 | 12313S007 | IRKJ | — | — |
| 1893 | KTZL | Katzively, | 18931801 | 12337S006 | CRAO | CRIMEA | — |
| | | Ukraine | | | | | |
| 7040 | OCTL | Wrightwood, | 70409201 | 49901S001 | — | — | — |
| | | California | | | | | |
| 7045 | APOL | Apache Point, | 70459501 | 49447S001 | — | — | — |
| | | NM | | | | | |
| 7080 | MDOL | McDonald | 70802419 | 40442M006 | MDO1 | FD-VLBA | — |
| | | Observatory, | | | | | |
| | | Texas | | | | | |
| 7090 | YARL | Yarragadee, | 70900513 | 50107M001 | YAR2 | YARRA12M | YASB |
| | | Australia | | | YAR3 | | |
| | | | | | YARR | | |
| 7105 | GODL | Greenbelt, | 71050725 | 40451M105 | GODE | GGAO12 | GRFB |
| | | Maryland | | | GODZ | | |
| | | | | | GODN | | |
| | | | | | GODS | | |
| 7110 | MONL | Monument | 71100412 | 40497M001 | MONP | — | — |
| | | Peak, | | | | | |
| | | California | | | | | |
| 7119 | HA4T | Haleakala, | 71191402 | 40445S009 | MAUI | — | — |
| | | Hawaii | | | | | |
| 7124 | THTL | Tahiti, French | 71240802 | 92201M007 | FAAA | — | PAUB |
| | | Polynesia | | | THTI | | |
| | | | | | THTG | | |
| | | | | | TAH1 | | |
| | | | | | TAH2 | | |
| 7231 | WUHL | Wuhan, China | 72312901 | 21602S004 | WUHN | — | JIUB |
| 7237 | CHAL | Changchun, | 72371901 | 21611S001 | CHAN | — | — |
| | | China | | | | | |
| 7249 | BEIL | Beijing, China | 72496102 | 21601S004 | BJFS | — | — |
| 7308 | KOGC | Koganei, Japan | 73085001 | 21704S002 | KGNI | KOGANEI | — |
| | | (CRL) | | | | | |
| 7358 | GMSL | Tanegashima, | 73588901 | 21749M001 | GMSD | — | — |
| | | Japan | | | | | |
| 7359 | DAEK | Daedeok, | 73592601 | 23902S002 | DAEJ | — | — |
| | | Republic of | | | | | |
| | | Korea | | | | | |
| 7403 | AREL | Arequipa, Peru | 74031306 | 42202M003 | AREG | — | ARFB |
| | | | | | AREQ | | |
| | | | | | AREV | | |
| 7405 | CONL | Concepcion, | 74057904 | 41719M001 | CONZ | TIGOCONC | — |
| | | Chile | | | CONT | | |
| 7406 | SJUL | San Juan, | 74068801 | 41508S003 | — | — | — |
| | | Argentina | | | | | |
| 7407 | BRAL | Brasilia, Brazil | 74072701 | 48081S001 | — | — | — |
| 7501 | HARL | Hartebeesthoe, | 75010602 | 30302M003 | HARB | HARTRAO | HRMB |
| | | South Africa | | | HRAO | HART15M | |
| 7806 | METL | Metsahovi, | 78067601 | 10503S014 | METS | tbd | MEUB |
| | | Finland | | | | | |
| 7810 | ZIML | Zimmerwald, | 78106801 | 14001S007 | ZIMM | — | — |
| | | Switzerland | | | ZIM2 | | |
| | | | | | ZIMJ | | |
| 7811 | BORL | Borowiec, | 78113802 | 12205S001 | BOR1 | — | — |
| | | Poland | | | | | |
| 7820 | KUNL | Kunming, China | 78208201 | 21609S002 | KUNM | KUNMING | — |
| 7821 | SHA2 | Shanghai, China | 78212801 | 21605S010 | SHAO | SESHAN25 | — |
| 7824 | SFEL | San Fernando, | 78244502 | 13402S007 | SFER | — | — |
| | | Spain | | | ROAP | | |
| 7825 | STL3 | Mt Stromlo, | 78259001 | 50119S003 | STR1 | — | MSPB |
| | | Australia | | | STR2 | | |
| 7827 | SOSW | Wettzell, | 78272201 | 14201S045 | WTZR | WETTZELL | — |
| | | Germany | | | WTZS | WETTZ13N | |
| | | | | | WTZA | | |
| | | | | | WTZZ | | |
| 7831 | HLWL | Helwan, Egypt | 78314601 | 30101S001 | — | — | — |
| 7832 | RIYL | Riyadh, Saudi | 78325501 | 20101S001 | SOLA | — | — |
| | | Arabia | | | | | |
| 7838 | SISL | Simosato, Japan | 78383603 | 21726S001 | SMST | — | — |
| 7839 | GRZL | Graz, Austria | 78393402 | 11001S002 | GRAZ | — | — |
| 7840 | HERL | Herstmonceu, | 78403501 | 13212S001 | HERS | | |
| | | United Kingdom | | | HERT | | |
| 7841 | POT3 | Potsdam, | 78418701 | 14106S011 | POT3 | — | — |
| | | Germany | | | | | |
| 7845 | GRSM | Grasse, France | 78457801 | 10002S002 | GRAS | — | GRAB |
| | | (LLR) | | | GRAC | | |
| 7941 | MATM | Matera, Italy | 79417701 | 12734S008 | MATE | MATERA | — |
| | | (MLRO) | | | MAT1 | | |
| 8834 | WETL | Wettzell, | 88341001 | 14201S018 | WTZR | WETTZELL | — |
| | | Germany | | | WTZS | WETTZ13N | |
| | | (WLRS) | | | WTZA | | |
| | | | | | WTZZ | | |

### Facility and Operations

According to various embodiments, the GGAOs 1.2 m telescope laser ranging station can be used to achieve meter-level range accuracy on cooperative satellite targets as well as large, uncooperative debris targets. Many newly launched assets incorporate externally mounted, Earth-facing retro reflectors so ground based laser ranging installations can use them as cooperative targets. These retro reflectors greatly increase the effective laser link margin and create numerous opportunities for orbital refinement throughout a mission as well as aiding the geodetic community. In 2005, NASA used the system to achieve and active optical link with the Messenger spacecraft, as it was on its way to Mercury. The Mercury Laser Altimeter (MLA) instrument was aimed at Earth and the 1.2 m telescope configured to track Messenger. Each system engaged its laser lidar/ranging systems and is able to achieve an active optical link between the two instruments on multiple occasions. This 24×10⁶ km link allowed the Messenger team to perform unique in-situ operational calibration and tests with its altimeter system, otherwise not possible prior to reaching its planetary destination. This feat fully demonstrates the facilities ability to track and bore site to difficult, unique targets of opportunity, and achieve few photon level waveform capture in a relatively high light pollution environment.

According to various embodiments of the present invention, ODLR can serve as an experimental baseline for developing an optimized system for laser ranging to smaller, noncompliant (skin tracking) targets. According to various embodiments, methods can focus on continuing efforts to identify and track large uncooperative orbital debris (without retro-reflectors). Laser and detector hardware can be optimized for locating and tracking smaller (about 10 cm) debris targets. According to various embodiments, GGAO can utilize NASA's in-house SLR expertise and its membership in the ILRS with active stations worldwide, as shown in Table 1 above, to offer a unique opportunity to rapidly adapt high resolution SLR techniques to address the growing orbital debris problem.

According to various embodiments, SLR techniques can be employed at GGAO to find new debris, improve tracking of known debris, and measure tumble rates on larger objects. In some embodiments, the illumination of a specific target by an SLR system for optical tracking can be used by a spacecraft as a target to characterize diffuse reflection of directed laser energy from the SLR system, of a known passive target, which can be optically tracked by another station. This added capability enables multiple optical sites to passively track illuminated targets for further enhancement of orbital predictions, further adding to the orbital database without the necessity of having high precision laser ranging capability at every station of the network.

### ODLR Detection and Tracking Methods

The current conjunction assessment process of predicting the probability of collision is often insufficient to provide truly “actionable” information for maneuver decisions. Calculating the probability of collision involves estimating and propagating the state and covariance of both the spacecraft and the debris object. As the uncertainty in the debris object's state increases, so does the false alarm and missed detection rate. As a result, hypothetically the next on-orbit collision may have been predicted, but with insufficient precision to justify an avoidance maneuver.

The more accurate (and conversely, with lower variance) estimate of the debris object orbit leads to more precise calculation of the probability of collision with greater confidence. As a result, “false detections” (where collision avoidance maneuvers are preformed unnecessarily) occur less frequently, reducing operational complexity and cost. Also, better estimates of collision probabilities also reduce the risk of a missed detection, potentially preventing a collision. SLR, according to the present invention, thus enables the conjunction analysis end-user to receive fewer collision warnings, with higher confidence levels, and more actionable information.

High-accuracy tracking data, achievable with ODLR according to the present invention, significantly improves existing prediction models for these highly random and changing targets. Improving these models provides more time for spacecraft to avoid potential impacts and reduces the significant number of expensive and time-consuming maneuvers executed due to false alarms. Improving the debris object's orbit estimate results in a more accurate probability of collision calculation. According to various embodiments of the present invention, the inclusion of SLR techniques into the current RADAR debris grid, models, and current SLR operations to friendly targets, the absolute range accuracy improves by 10× or more depending on target size, albedo, orbit, and shape. Thus, the inclusion of this active orbital range measurement technology can also be used to improve the orbital estimates of 48-72 hour conjunction predictions.

### ODLR Network Operation

As of 2015, the GSFC Flight Dynamics Facility (FDF) was providing Conjunction Assessment Risk Mitigation support for more than 80 NASA missions. The JSpOC provides close approach predictions data to the NASA Robotic Conjunction Assessment Risk Analysis (CARA) Team, also at GSFC. The CARA team analyzes the JSpOC data, and performs a risk analysis to quantify threats. The CARA team provides risk assessment analysis results and trends to the Mission Flight and Operations Teams and makes recommendations, if required, to Mission Operations Teams concerning maneuver avoidance planning. While the CARA process provides important risk assessments, any close approach prediction requires significant analysis and quick turnaround work to disprove, and requires several meetings with the mission team to describe risk and build confidence that it is just a false alarm. Thus, the reduction in false predictions, risk analysis time and cost, provided by the ODLR laboratory provides additional benefits to both GSFC FDF and JSpOC.

The Joint Space Operations Center is currently upgrading the JSpOC Mission System (JMS) that will deliver an integrated Command and Control (C2) and Space Situational Awareness (SSA) capability to Joint Functional Component Command (JFCC) Space. The Service-Oriented Architecture (SOA) infrastructure enables interoperability and adaptability with the non-Department of Defense community, including NASA. The Ground-Based Laser Ranging at NASA-GSFC for Identification and Tracking of Orbital Debris system data and flight dynamics products can be integrated into their External Space and Other Support Services part of the overall JMS.

A dedicated ODLR laboratory can provide an important baseline analysis capability for evolving orbital debris characteristics that can define and drive requirements for orbital debris removal design concepts. The analysis can facilitate the validation of current and future designs and concepts.

GGAO's 1.2 m facility can be adapted for ODLR operations with meter-level and finer tracking accuracies to uncooperative large targets and to smaller sub-meter targets. Based on initial demonstration tracks, data can be incorporated into a model and link margin calculations to produce a to-do list of remaining upgrades and operations enhancements to produce the highest level of accuracy possible, and to link to the smallest target possible, at least on a case-to-case confirmation basis. Other international SLR sites, in cooperation with Goddards GGAO, can be adapted to periodically track LEO debris, and improve the multi-site advantages toward solving this problem. Dedicated ODLR sites can be installed worldwide with near real-time orbital and tracking data feeding into the JSpOC and SSA databases, for example, at sister ILRS stations in Australia, France, and Austria. NASA's involvement can provide the critical mass needed to enable a global network of dedicated ODLR sites for debris tracking and aid in abatement processes. The laser-based tracking of orbital debris provides another layer of detection and protection of valuable space assets, currently not available through any other, readily active means.

Each of the following references is incorporated herein in its entirety by reference:

[1] NASA Orbital Debris Program Office, “Orbital Debris Frequently Asked Questions”, March (2012). http ://www.orbitaldebris.jsc.nasa.gov/faqs.html#3.

[2] McKie, Robin and Day, Michael “Warning of catastrophe from mass of ‘space junk’” The Observer, 24 Feb. (2008).

[3] McGarry, J. Zagwodzki, T. and Degnan, J. J., “Large aperture high accuracy satellite laser tracking,” SPIE 641, 77-83, (1986).

[4] Pearlman, et al, “NASA's Next Generation Space Geodesy Program,” http://space-geodesy.nasa.gov/docs/2012/sgp_aogs_120813.pdf, (2012).

[5] International Technical Laser Workshop, “Satellite, Lunar and Planetary Laser Ranging: characterizing the space segment”, (2012). http://www.lnf.infn.it/conference/laser2012/

[6] David E. Smith, Maria T. Zuber, Xiaoli Sun, Gregory A. Neumann, John F. Cavanaugh, Jan F. McGarry, Thomas W. Zagwodzki, “Two-way laser link over interplanetary distance”, Science, 311, 53, (2006).

[7] Pearlman, M. R., Degnan, J. J., and Bosworth, J. M., “The International Laser Ranging Service”, Advances in Space Research, Vol. 30, No. 2, pp. 135-143, July 2002, DOI:10.1016/50273 -1177(02)00277-6.

[8] Courde, Clement, “Laser ranging on space debris with the MeO station”, OCA, France, Proc. International Technical Laser Workshop 2012, Frascati, Italy, (2012).

[9] Georg, Kirchner, “Laser tracking of space debris at SLR Graz”, Austrian Academy of Sciences, Austria, Proc. International Technical Laser Workshop 2012, Frascati, Italy, (2012).

[10] Smith, Craig, et al. “LASER TRACKING OF SPACE DEBRIS FOR PRECISION ORBIT DETERMINATION.” Advances in the Astronautical Sciences 142 (2011).

[11] NASA Robotic Conjunction Assessment Risk Analysis (CARA) Effort: Background and Overview, Lauri Newman, Romae Young Jan. 19, (2010).

The present invention includes the following numbered aspects, embodiments, and features, in any order and/or in any combination:

1. A system of laser ranging tracking facilities for tracking an orbital debris target in low Earth orbit, the system comprising:

a plurality of laser ranging stations comprising at least two ground-based laser ranging stations separated from one another by at least 100 miles, each laser ranging station comprising a transmitter for transmitting a respective signal indicative of the orbit of the orbital debris target;

a receiver configured to receive the signals from the laser ranging stations;

a processor configured to process the signals received by the receiver into data sets each pertaining to the orbit of the orbital debris target; and

a datastore configured to store the data sets pertaining to the orbit of the orbital debris target, wherein at least one of the ground-based laser ranging stations comprises a high power laser configured to provide laser pulses at a wavelength of from 1.4 μm to 1.9 μm at a pulse energy of 100 mJ or greater and at a repetition rate of from 10 Hz to 100 Hz.

2. The system of any preceding or following embodiment/feature/aspect, wherein the processor is further configured to:

process the data sets into orbital data pertaining to the orbit of the orbital debris target;

store the orbital data in the datastore; and

calculate a future orbit path of the orbital debris target based on the stored orbital data.

3. The system of any preceding or following embodiment/feature/aspect, wherein the high power laser is configured to provide pulsed laser light at a wavelength of about 1.5 μm.

4. The system of claim 1, further comprising at least one laser ranging satellite configured to laser range the orbital debris target and transmit a signal to the receiver indicative of the orbit of the orbital debris target.

5. The system of any preceding or following embodiment/feature/aspect, wherein the laser ranging satellite comprises a high power laser configured to provide laser pulses at a wavelength from 1.0 μm to 1.9 μm at a pulse energy of 100 mJ or greater and at a repetition rate of from 10 Hz to 100 Hz.

6. The system of any preceding or following embodiment/feature/aspect, wherein the high power laser of the laser ranging satellite is configured to provide pulsed laser light at a wavelength of about 1.5 μm.

7. The system of any preceding or following embodiment/feature/aspect, further comprising a radio frequency radar station configured to track the orbital debris target and transmit a respective signal indicative of the orbit of the orbital debris target, to the receiver, wherein the receiver is further configured to receive signals from the radio frequency radar station.

8. The system of any preceding or following embodiment/feature/aspect, further comprising a passive optical tracking radar station configured to track the orbital debris target and transmit a respective signal indicative of the orbit of the orbital debris target, to the receiver, wherein the receiver is further configured to receive signals from the passive optical tracking radar station.

9. A method tracking an orbital debris target in low Earth orbit, the method comprising: laser ranging the orbital debris target using a plurality of laser ranging stations comprising at least two ground-based laser ranging stations, the at least two ground-based laser ranging stations being separated from one another by at least 100 miles;

transmitting a respective signal from each of the laser ranging stations indicative of the orbit of the orbital debris target;

receiving at a receiver the transmitted signals from the laser ranging stations;

processing the signals received by the receiver into data sets each pertaining to the orbit of the orbital debris target; and

storing in a datastore the data sets pertaining to the orbit of the orbital debris target,

wherein at least one of the ground-based laser ranging stations laser ranges with a high power laser that provides laser pulses at a wavelength of from 1.4 μm to 1.9 μm at a pulse energy of 100 mJ or greater and at a repetition rate of from 10 Hz to 100 Hz.

10. The method of any preceding or following embodiment/feature/aspect, wherein the processor:

processes the data sets into orbital data pertaining to the orbit of the orbital debris target;

stores the orbital data in the datastore; and

calculates a future orbit path of the orbital debris target based on the stored orbital data.

11. The method of any preceding or following embodiment/feature/aspect, wherein the high power laser provides pulsed laser light at a wavelength of about 1.5 μm.

12. The method of any preceding or following embodiment/feature/aspect, further comprising laser ranging the orbital debris target with at least one laser ranging satellite and transmitting a satellite signal from the laser ranging satellite to the receiver, the satellite signal being indicative of the orbit of the orbital debris target, wherein the receiver receives the satellite signal and the processing further comprises processing the satellite signal into a data set pertaining to the orbit of the orbital debris target.

13. The method of any preceding or following embodiment/feature/aspect, wherein the laser ranging satellite produces high power laser pulses at a wavelength from 1.0 μm to 1.9 μm at a pulse energy of 100 mJ or greater and at a repetition rate of from 10 Hz to 100 Hz.

14. The method of any preceding or following embodiment/feature/aspect, wherein the high power laser of the laser ranging satellite produces pulsed laser light at a wavelength of about 1.5 μm.

15. The method of any preceding or following embodiment/feature/aspect, further comprising tracking the orbital debris target with a radio frequency radar station and transmitting a respective signal indicative of the orbit of the orbital debris target, to the receiver, wherein the receiver receives signals from the radio frequency radar station and the processing further comprises processing the signal received from the radio frequency radar station into a data set pertaining to the orbit of the orbital debris target.

16. The method of any preceding or following embodiment/feature/aspect, further comprising tracking the orbital debris target with a passive optical tracking station and transmitting a respective signal indicative of the orbit of the orbital debris target, to the receiver, wherein the receiver receives signals from the passive optical tracking station and the processing further comprises processing the signal received from the passive optical tracking station into a data set pertaining to the orbit of the orbital debris target.

17. The method of any preceding or following embodiment/feature/aspect, wherein the orbital debris target is a non-compliant target, an uncooperative target, or both.

18. The method of any preceding or following embodiment/feature/aspect, further comprising optically tracking the orbital debris target with a passive optical tracking station based on the data sets stored in the datastore.

19. The method of any preceding or following embodiment/feature/aspect, further comprising:

tracking a second orbital debris target using the plurality of laser ranging stations;

storing in the datastore data sets pertaining to the orbit of the second orbital debris target; and

cataloging in the datastore the data sets of both the orbital debris target and the second orbital debris target.

20. The method of any preceding or following embodiment/feature/aspect, further comprising comparing information from the cataloged data sets to positional information pertaining to a low Earth orbit asset and repositioning the asset based on the comparison.

The present invention can include any combination of these various features or embodiments above and/or below as set-forth in sentences and/or paragraphs. Any combination of disclosed features herein is considered part of the present invention and no limitation is intended with respect to combinable features.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Herein the term “about” is intended to encompass a deviation of from plus 5% to minus 5% of the value modified. So, for example, by “about 1.5 μm,” what is meant is from 1.425 μm to 1.575 μm.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A system of laser ranging tracking facilities for tracking an orbital debris target in low Earth orbit, the system comprising:
a plurality of laser ranging stations comprising at least two ground-based laser ranging stations separated from one another by at least 100 miles, each laser ranging station comprising a transmitter for transmitting a respective signal indicative of the orbit of the orbital debris target;
a receiver configured to receive the signals from the laser ranging stations;
a processor configured to process the signals received by the receiver into data sets each pertaining to the orbit of the orbital debris target; and
a datastore configured to store the data sets pertaining to the orbit of the orbital debris target, wherein at least one of the ground-based laser ranging stations comprises a high power laser configured to provide laser pulses at a wavelength of from 1.4 μm to 1.9 μm at a pulse energy of 100 mJ or greater and at a repetition rate of from 10 Hz to 100 Hz.

2. The system of claim 1, wherein the processor is further configured to:
process the data sets into orbital data pertaining to the orbit of the orbital debris target;
store the orbital data in the datastore; and
calculate a future orbit path of the orbital debris target based on the stored orbital data.

3. The system of claim 1, wherein the high power laser is configured to provide pulsed laser light at a wavelength of about 1.5 μm.

4. The system of claim 1, further comprising at least one laser ranging satellite configured to laser range the orbital debris target and transmit a signal to the receiver indicative of the orbit of the orbital debris target.

5. The system of claim 4, wherein the laser ranging satellite comprises a high power laser configured to provide laser pulses at a wavelength from 1.0 μm to 1.9 μm at a pulse energy of 100 mJ or greater and at a repetition rate of from 10 Hz to 100 Hz.

6. The system of claim 5, wherein the high power laser of the laser ranging satellite is configured to provide pulsed laser light at a wavelength of about 1.5 μm.

7. The system of claim 1, further comprising a radio frequency radar station configured to track the orbital debris target and transmit a respective signal indicative of the orbit of the orbital debris target, to the receiver, wherein the receiver is further configured to receive signals from the radio frequency radar station.

8. The system of claim 1, further comprising a passive optical tracking radar station configured to track the orbital debris target and transmit a respective signal indicative of the orbit of the orbital debris target, to the receiver, wherein the receiver is further configured to receive signals from the passive optical tracking radar station.

9. A method of tracking an orbital debris target in low Earth orbit, the method comprising:
laser ranging the orbital debris target using a plurality of laser ranging stations comprising at least two ground-based laser ranging stations, the at least two ground-based laser ranging stations being separated from one another by at least 100 miles;
transmitting a respective signal from each of the laser ranging stations indicative of the orbit of the orbital debris target;
receiving at a receiver the transmitted signals from the laser ranging stations;
processing the signals received by the receiver into data sets each pertaining to the orbit of the orbital debris target; and
storing in a datastore the data sets pertaining to the orbit of the orbital debris target, wherein at least one of the ground-based laser ranging stations laser ranges with a high power laser that provides laser pulses at a wavelength of from 1.4 μm to 1.9 μm at a pulse energy of 100 mJ or greater and at a repetition rate of from 10 Hz to 100 Hz.

10. The method of claim 9, wherein the processor:
processes the data sets into orbital data pertaining to the orbit of the orbital debris target;
stores the orbital data in the datastore; and
calculates a future orbit path of the orbital debris target based on the stored orbital data.

11. The method of claim 9, wherein the high power laser provides pulsed laser light at a wavelength of about 1.5 μm.

12. The method of claim 9, further comprising laser ranging the orbital debris target with at least one laser ranging satellite and transmitting a satellite signal from the laser ranging satellite to the receiver, the satellite signal being indicative of the orbit of the orbital debris target, wherein the receiver receives the satellite signal and the processing further comprises processing the satellite signal into a data set pertaining to the orbit of the orbital debris target.

13. The method of claim 12, wherein the laser ranging satellite produces high power laser pulses at a wavelength from 1.0 μm to 1.9 μm at a pulse energy of 100 mJ or greater and at a repetition rate of from 10 Hz to 100 Hz.

14. The method of claim 13, wherein the high power laser of the laser ranging satellite produces pulsed laser light at a wavelength of about 1.5 μm.

15. The method of claim 9, further comprising tracking the orbital debris target with a radio frequency radar station and transmitting a respective signal indicative of the orbit of the orbital debris target, to the receiver, wherein the receiver receives signals from the radio frequency radar station and the processing further comprises processing the signal received from the radio frequency radar station into a data set pertaining to the orbit of the orbital debris target.

16. The method of claim 9, further comprising tracking the orbital debris target with a passive optical tracking station and transmitting a respective signal indicative of the orbit of the orbital debris target, to the receiver, wherein the receiver receives signals from the passive optical tracking station and the processing further comprises processing the signal received from the passive optical tracking station into a data set pertaining to the orbit of the orbital debris target.

17. The method of claim 9, wherein the orbital debris target is a non-compliant target, an uncooperative target, or both.

18. The method of claim 9, further comprising optically tracking the orbital debris target with a passive optical tracking station based on the data sets stored in the datastore.

19. The method of claim 9, further comprising:
tracking a second orbital debris target using the plurality of laser ranging stations;
storing in the datastore data sets pertaining to the orbit of the second orbital debris target; and
cataloging in the datastore the data sets of both the orbital debris target and the second orbital debris target.

20. The method of claim 19, further comprising comparing information from the cataloged data sets to positional information pertaining to a low Earth orbit asset and repositioning the asset based on the comparison.
